(19) United States
(12) Patent Application Publication
(10) Pub. No.: US 2005/0057949 A1
(43) Pub. Date: Mar. 17, 2005

(54) 12th active filter capable of concurrently removing 11th and 13th harmonics

(76) Inventors: Chan Ki Kim, Daejeon (KR); Jeong Shik Ahn, Daejeon (KR); Gil Jo Jung, Daejeon (KR); Seok Jin Lee, Gyeonggi-do (KR); Jin Cheol Shin, Seoul (KR)

Correspondence Address: Michael A. Cantor, 55 Griffin South Road, Bloomfield, CT, 06002, US

(21) Appl. No.: 10/735,537

(22) Filed: Dec. 12, 2003

(30) Foreign Application Priority Data
Sep. 17, 2003 (KR) 2003-64389

(51) Int. Cl. H02M 5/45

(52) U.S. Cl. 363/37

(57) ABSTRACT

The present invention relates to a 12^{th} active filter capable of concurrently removing 11^{th} and 13^{th} harmonics in order to obtain a filter performance capable of removing 11^{th} and 13 harmonics even when a filter capable of removing 11^{th} and 13^{th} harmonics is constituted using a compensation function. The 12^{th} active filter capable of concurrently removing 11^{th} and 13^{th} harmonics is characterized in that a passive filter 7-1 formed of a condenser 7-1-1, an inductance 7-1-2 and a resistor 7-1-3 is formed of the phases A, B and C, and the passive filter 7-1 of each phase is formed in a three-phase structure in which a switch 7-3 and a voltage source converter 7-4 are connected through a transformer 7-2, and in the voltage source converter 7-4, V1˜V6 of a firing unit 7-7 are connected with the bases of the transistors of semiconductor devices V1˜V6, respectively, and a control unit 7-6 connected with a signal detection unit 7-5 is connected with the firing unit 7-7 for thereby removing 11^{th} and 13^{th} harmonics.

### BACKGROUND OF THE INVENTION

1. Field of the Invention

The present invention relates to a 12^{th} active filter capable of concurrently removing 11^{th} and 13^{th} harmonics in order to obtain a filter performance capable of removing 11^{th} and 13 harmonics even when a filter capable of removing 11^{th} and 13^{th} harmonics is constituted using a compensation function.

2. Description of the Background Art

Generally, a HVDC (High Voltage Direct Current) system or a facility constructed based on a power electronic equipment is known to generate harmonics. The above harmonics decrease a life span of electric instruments and a power quality. In worse case, a system may be entirely damaged. A filter is necessarily used for removing harmonics near a harmonic source, which generate harmonics.

The filter capable of removing harmonics is classified into a passive filter using a resistor, condenser and inductance, a passive filter capable of removing harmonics by inputting a waveform opposite to a certain harmonic into a harmonic using a converter, and a hybrid filter formed by combining a passive filter and an active filter. Namely, the hybrid filter is formed in such a manner that a passive filter is connected to a converter of an active filter through a transformer. Here, the hybrid filter has an economical advantage of a passive filter and a control accuracy of an active filter. Generally, the hybrid filter is classified as an active filter.

FIG. 1 is a view illustrating a conventional passive filter used for removing 11^{th} and 13^{th} current harmonic existing in a system. The passive filter is designed to pass or not to pass a certain frequency band using a resistor, condenser and inductance. The 11^{th} and 13^{th} passive filters are designed to remove 11^{th} and 13^{th} current harmonics based on a basic frequency of 60 Hz and are formed of a resistor, condenser and inductance.

The passive filter is formed of an inductance 1-1, a condenser 1-2 and a resistor 1-3. The passive filter is set so that parallel impedance is minimized in a harmonic band that will be removed. In the 11^{th} filter, an inductance L11, a condenser C11 and a resistor R11 are connected in series. In the 13^{th} filter in which the 11^{th} filter is connected in parallel, an inductance L13, a condenser C13 and a resistor R13 are connected in series.

The resistor 1-3 is adapted to determine a frequency bandwidth, which will be filtered. When a resistance is high, the frequency band of a harmonic is widened, but a filtering effect is decreased. When a resistance is small, the frequency band of a harmonic, which will be removed, becomes narrow, but a filtering effect is increased. If a converter operating as an equivalent resistor is added to a passive filter instead of using a resistor, it is possible to increase a filtering effect and to widen a bandwidth of a frequency, which will be filtered. The active filter has the above functions.

FIG. 2 is a view illustrating an active filter formed in such a manner that the 11^{th} and 13^{th} passive filters 2-1 of FIG. 1 and a three-phase converter 2-4 are connected through a transformer 2-2. The active filter is designed to pass or not to pass a certain frequency band using a semiconductor device. The 11^{th} and 13^{th} active filters are adapted to offset the 11^{th} and 13^{th} current harmonics based on a basic frequency of 60 Hz using a switching of converter.

The passive 11^{th} filter 2-1-1 and the passive 13^{th} filter 2-1-2 are connected in parallel, and a switch 2-3 and a voltage source converter 2-4 are connected through a transformer 2-2 for thereby forming a three-phase structure. In the voltage source converter 2-4, V1˜V6 of a firing unit 2-7 is connected to the semiconductor device (V1˜V6). A controller 2-6 and a signal detection unit 2-5 are connected with the firing unit 2-7. The phase A is formed of the passive 11^{th} filter 2-1-1 and the passive 13^{th} filter 2-1-2. The phase A is connected with the phase B and phase C in parallel for thereby forming a three-phase structure. The transformer 2-2 is formed in n:1.

When there is only a converter 2-4 of the active filter, the cost of the system is very expensive. When there is only a passive filter 2-1, the filtering effect is decreased. The above problems are overcome by the three-phase structure. The firing unit 2-7 is adapted to drive the voltage source converter 2-4. The control unit 2-6 is adapted to generate a firing signal. The signal detection unit 2-5 is adapted to detect a signal from the system. The active filter has a switch 2-3 so that the active filter may be used as a passive filter in the case of an error of the converter.

The voltages Va, Vb and Vc are inputted into the signal detection unit 2-5. In six semiconductor devices V1˜V6 of the voltage source converter 2-4, a transistor 2-4-1 and a diode 2-4-2 are connected in parallel. The converter is a power converter for converting a direct current signal into an alternating current signal or converting an alternating current signal into a direct current signal using a semiconductor device. The firing unit 2-7 outputs voltages V1˜V6. The voltages V1˜V6 are inputted into the semiconductor device V4, V1 of the phase A, the semiconductor device V6, V3 of the phase B, and the semiconductor device V2, V5 of the phase C of the voltage source converter 2-4, respectively.

In the power conversions of the semiconductor device V4, V1 of the phase A, the semiconductor device V6, V3 of the phase B, and the semiconductor device V2, V5 of the phase C, the on and off operations are performed as the voltages V1˜V6 of the firing unit 2-7 are supplied to the base of the transistor 2-4-1 provided in the semiconductor device of each phase.

As shown in FIG. 3, the firing unit will be described. Since the voltage source converter 2-4 of FIG. 2 performs a PWM (Pulse Width Modulation) control, a comparison signal with respect to a certain reference signal should be provided. Therefore, the firing unit 2-7 of FIG. 2 is designed to compare a control command value from the control unit 2-6 with a triangle wave and to switch the converter 2-4 having six semiconductor devices V1˜V6.

FIG. 3 is a view illustrating an internal wiring structure of the firing unit 2-7 of FIG. 2. A triangle wave passed through the triangle wave generation unit 3-1 by each phase, and a signal from the control unit 2-6, namely, a signal obtained by combining the signals from the command units 3-3 and 3-4 using a combining unit are turned on and off using a comparison unit 3-2. In the converter 2-4 of the active filter, since the semiconductor devices V1 and V4 are connected in one phase in series, there is provided an inverter 3-5 for preventing conduction and on and off operation.

In the command units 3-3 and 3-4, there are provided the command units A13 and All of the phase A, the command units B13 and B11 of the phase B, and the command units C13 and C11 of the phase C. In the comparison unit 3-2 of each phase, the semiconductor device V1, and the semiconductor device V4 passed through the inverter 3-5 are connected with the phase A. the semiconductor device V3, and the semiconductor device V6 passed through the inverter 3-5 are connected with the phase B. The semiconductor device V5, and the semiconductor device V2 passed through the inverter 3-5 are connected with the phase C.

FIGS. 4 and 5 are views illustrating the constructions that a command value is provided to the command units 3-3 and 3-4 of FIG. 3, respectively. FIG. 4 is a view illustrating the construction that a command signal with respect to the 11^{th} harmonic is generated, and FIG. 15 is a view illustrating the construction that a command value with respect to the 13^{th} harmonic is generated.

FIG. 4 is a view illustrating the construction that a command value is generated to drive the voltage source converter 2-4 of the active filter of FIG. 2. In a vector control technique, a real number portion is formed by multiplying an item of cosine with the direct current signal. Multiplying an item of sine with the direct current signal forms an imaginary number portion. Combining the same forms the command signal. The vector control is implemented by dividing the alternating current three-phase signal into a real number portion and an imaginary number portion.

FIG. 4 is a view illustrating one part of the control unit 2-6 of FIG. 2. The signals V₁₁ₐ·cos θ₁₁ₐ obtained by vector-combining the value commanded by the command unit 4-1 and the voltage and phase from the signal detection unit 2-5 are combined by the combining unit 6-2 based on the scalar method. An error of the same is outputted through a PI control unit 4-3. The signals V₁₁ₐ·sin θ₁₁ₐ obtained vector-combining the value obtained by vector-combining a sin (11 ωt) of the frequency conversion unit 4-5 for converting the signal from the PI control unit 4-3 into a 11^{th} frequency, the value commanded by the command unit 4-8 and the voltage and phase from the signal detection unit 2-5 are combined by the combining unit 4-2 based on the scalar method. The combined value is outputted through the PI control unit 4-3. A cos (11 ωt) of the frequency conversion unit 4-9 adapted to convert the signal from the PI control unit 4-3 into a 11^{th} frequency and a value multiplied by the other multiplier 4-4 are combined by the combining unit 4-6 and are outputted to the command unit 3-4 of FIG. 3.

The vector combined signals V₁₁ₐ·cos θ₁₁ₐ are the output of a multiplexor 4-7. The input of the multiplexor 4-7 is connected with the voltage detection unit 4-11 and the phase detection unit 4-13. A 11^{th} harmonic size V₁₁ₐ is supplied to the portion 4-10 in the voltage detection unit 4-11, and the phase θ₁₁ₐ of the 11^{th} harmonic is supplied to the portion 4-12 of the phase detection unit 4-13. The vector combined signals V₁₁ₐ·sin θ₁₁ₐ are the output of the other multiplexor 4-7. The input of the multiplexor 4-7 is connected with the voltage detection unit 4-11 and the phase detection unit 4-13. A 11^{th} harmonic size V₁₁ₐ is supplied to the portion 4-10 in the voltage detection unit 4-11, and the phase θ₁₁ₐ of the 11^{th} harmonic is supplied to the portion 4-12 of the phase detection unit 4-13.

FIG. 5 is a view illustrating the construction that a signal is generated in the command unit 3-3 of FIG. 3 in the same manner as FIG. 4. FIG. 4 corresponds to the construction for generating a 11^{th} harmonic command signal, and FIG. 5 corresponds to the construction for generating a 13^{th} harmonic command value.

Namely, the signals V₁₃ₐ·cos θ₁₃ₐ obtained by vector-combining the value commanded by the command unit 5-1 and the voltage and phase from the signal detection unit 2-5 are scalar-combined by the combining unit 5-2. An error of the same is outputted through the PI control unit 5-3. The signals V₁₃ₐ·sin θ₁₃ₐ obtained by vector-combining a sine(13 ωt) of the frequency conversion unit 5-5 adapted to convert the signal from the PI control unit 5-3 into a 13^{th} frequency, the value multiplied by the multiplier 5-4, the value commanded by the command unit 5-8 and the voltage and phase from the signal detection unit 2-5 are scalar-combined by the other combining unit 5-2. The combined value is outputted through the PI control unit 5-3. Cos(13 ωt) of the frequency conversion unit 5-9 adapted to convert the signal from the PI control unit 5-3 into a 13^{th} frequency, and the value multiplied by the other multiplier 5-4 are combined by the combining unit 5-6 and are outputted to the command unit 3-3 of FIG. 3.

The vector combined signals V₁₃ₐ·cos θ₁₃ₐ are the output of the multiplexor 5-7. The input of the multiplexor 5-7 is connected with the voltage detection unit 5-11 and the phase detection unit 5-13. A 13^{th} harmonic size V₁₃ₐ is supplied to the portion 5-10 in the voltage detection unit 5-11, and the phase θ₁₃ₐ of the 13^{th} harmonic is supplied to the portion 5-12 of the phase detection unit 5-13.

The vector combined signals V₁₃ₐ·sin θ₁₃ₐ are the output of the other multiplexor 5-7. The input of the multiplexor 5-7 is connected with the voltage detection unit 5-11 and the phase detection unit 5-13. A 13^{th} harmonic size V₁₃ₐ is supplied to the portion 5-10 in the voltage detection unit 5-11, and the phase θ₁₃ₐ of the 13^{th} harmonic is supplied to the portion 5-12 of the phase detection unit 5-13.

FIG. 6 is a view illustrating the construction of the signal detection unit 2-5 of FIG. 2 in which the size and phase of the 11^{th} harmonic and the size and phase of the 13^{th} harmonic are computed from the phase voltage of the system. The computation of the size and phase of the harmonic from the phase voltage of the system are performed based on the FFT (Fast Fourier Transfer) method. The above FFT is a mathematical technique for interpreting the waveform including a harmonic or noise based on the Fourier Transfer of a sine function having different frequencies and sizes.

Namely, as Vₐ is inputted into the FFT, the size 6-1 of the 11^{th} harmonic which is V₁₁ₐ, the size 6-3 of the 13^{th} harmonic which is V₁₃ₐ, the phase 6-2 of the 11^{th} harmonic which is θ₁₁ₐ, and the phase 6-4 of the 13^{th} harmonic which is θ₁₃ₐ are outputted, respectively.

The 11^{th} and 13^{th} active filters (refer to FIG. 2) using the 11^{th} and 13^{th} passive filter (refer to FIG. 1) are directed to switch the semiconductor devices of the voltage source converter using the firing unit, the control unit and the signal detection unit of FIGS. 3˜6.

### SUMMARY OF THE INVENTION

Accordingly, it is an object of the present invention to provide a 12^{th} active filter. In a hybrid filter (hereinafter called active filter) used in the present invention, a performance of the passive filter is maximized using a converter. Even when the characteristics of the passive filter are changed by a temperature or degradation, the characteristic changes are compensated by the control function of the converter. Therefore, it is possible to implement a desired filter function capable of removing 11^{th} and 13^{th} harmonics even when the filter capable of removing 11^{th} and 13^{th} harmonics is constructed using only the 12^{th} filter using the compensation function.

To achieve the above objects, there is provided a 12^{th} active filter capable of concurrently removing 11^{th} and 13^{th} harmonics which is characterized in that a passive filter 7-1 formed of a condenser 7-1-1, an inductance 7-1-2 and a resistor 7-1-3 is formed of the phases A, B and C, and the passive filter 7-1 of each phase is formed in a three-phase structure in which a switch 7-3 and a voltage source converter 7-4 are connected through a transformer 7-2, and in the voltage source converter 7-4, V1˜V6 of a firing unit 7-7 are connected with the bases of the transistors of semiconductor devices V1˜V6, respectively, and a control unit 7-6 connected with a signal detection unit 7-5 is connected with the firing unit 7-7 for thereby removing 11^{th} and 13^{th} harmonics.

### BRIEF DESCRIPTION OF THE DRAWINGS

The present invention will become better understood with reference to the accompanying drawings which are given only by way of illustration and thus are not limitative of the present invention, wherein;

FIG. 1 is a circuit diagram illustrating a passive filter used for removing 11^{th} and 13^{th} harmonic current existing in the system;

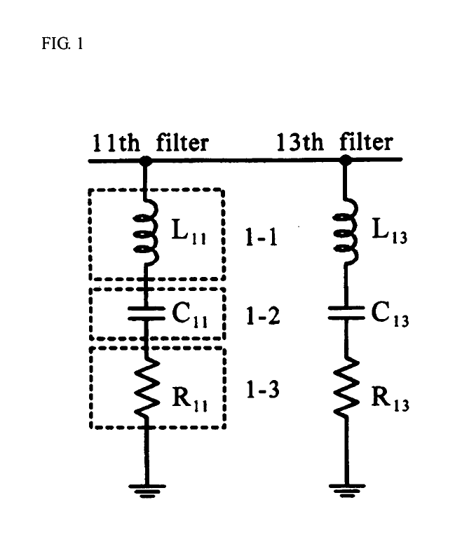

FIG. 2 is a circuit diagram illustrating a dynamic filter in which the 11^{th} and 13^{th} passive filter of FIG. 1 and a three-phase converter are connected through a transformer;

FIG. 3 is a circuit diagram illustrating an internal wiring construction of a firing unit of FIG. 2;

FIG. 4 is a view illustrating the construction that a command value is generated for driving a voltage source converter of the active filter of FIG. 2;

FIG. 5 is a view illustrating the construction that a signal is generated in a command unit of FIG. 3 like in FIG. 4;

FIG. 6 is a view illustrating the construction of a signal detection unit of FIG. 2; and

FIG. 7 is a circuit diagram illustrating a 12^{th} active filter according to the present invention being similar with FIG. 2 and formed of one passive filter.

### DETAILED DESCRIPTION OF THE PREFERRED EMBODIMENTS

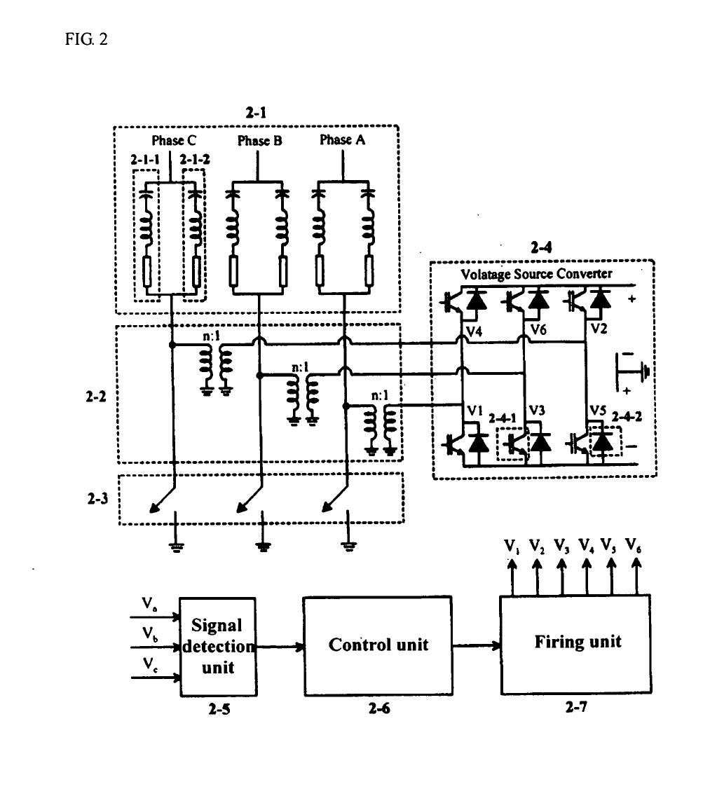

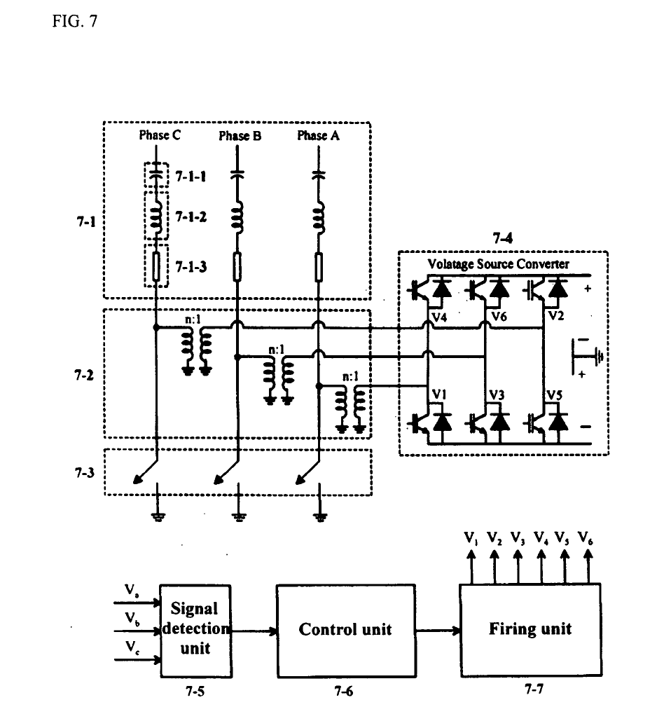

FIG. 7 is a circuit diagram illustrating a 12^{th} active filter according to the present invention being similar with FIG. 2 and formed of one passive filter. The present invention relates to a 12^{th} active filter capable of concurrently removing 11^{th} and 13^{th} harmonics for obtaining a filter performance capable of removing 11^{th} and 13^{th} harmonics even when a filter capable of removing 11^{th} and 13^{th} harmonics is constructed using a compensation function.

Namely, the present invention is similar with the construction of FIG. 2. In the present invention, there is provided one passive filter 7-1. The condenser 7-1-1, the inductance 7-1-2 and the impedance of the resistor 7-1-3 of the passive filter 7-1 of the present invention are adjusted to be minimum in the 12^{th} harmonic. Even when the characteristics are changed due to a temperature or degradation, the passive filter 7-1 has ability that the characteristic changes are compensated by a control function of the voltage source converter 7-7. Therefore, the 12^{th} passive filter having a simple structure is changed to a new 12^{th} active filter using the voltage source converter 7-7.

The passive filter 7-1 formed of the condenser 7-1-1, the inductance 7-1-2 and the resistor 7-1-3 are formed of the phases A, B and C. The passive filter 7-1 of each phase is formed in a three-phase structure in which a switch 7-3 and the voltage source converter 7-4 4 are connected through a transformer 7-2. In the voltage source converter 7-4, V1˜V6 of a firing unit 7-7 are connected with the base of the transistor of the semiconductor devices V1˜V6, respectively. A control unit 7-6 connected with a signal detection unit 7-5 is connected with the firing unit 7-7 for thereby concurrently removing the 11^{th} and 13^{th} harmonics.

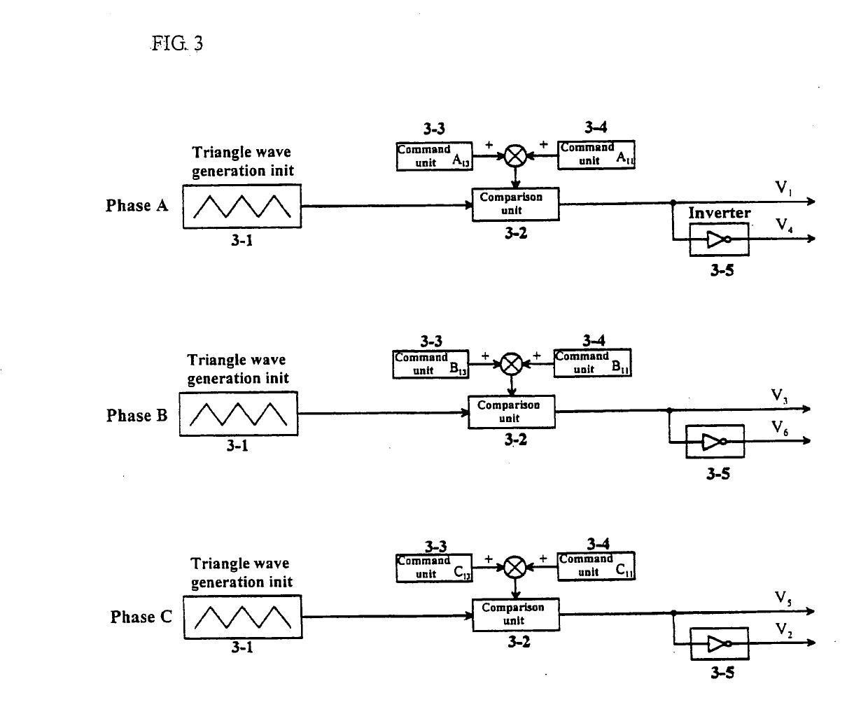

As shown in FIG. 7, the passive filter 7-1 is adjusted to a 12^{th} harmonic. Since the voltage source converter 7-4 uses the control units of FIGS. 3, 4, 5 and 6, the 12^{th} active filter of FIG. 7 is capable of removing 11^{th} and 13^{th} harmonics.

Namely, as shown in FIG. 3, in the internal wiring construction of the firing unit 7-7, a triangle wave formed through a triangle wave generation unit 3-1 with respect to each phase expressed in the phases A, B and C in the three-phase structure, and a signal from the control unit 7-6, namely, a signal combined the signals from the command units 3-3 and 3-4 are on and off by the comparator 3-2. Since the converter 7-4 of the active filter has the semiconductor devices V1 and V4 in one phase in a series form, there is provided an inverter 3-5 for preventing a concurrent conduction and performing an on and off function.

The command units 3-3 and 3-4 are formed of the command units A13 and A11 of the phase A, the command units B13 and B11 of the phase B, and the command units C13 and C11 of the phase C. In the comparator 3-2 of each phase, the semiconductor device V4 passed through the semiconductor device V1 and the inverter 3-5 is connected with the phase A. The semiconductor device V6 passed through the semiconductor device V3 and the inverter 3-5 is connected with the phase B. The semiconductor device V2 passed through the semiconductor device V5 and the inverter 3-5 is connected with the phase C. Therefore, the converter 7-4 having six semiconductor devices V1˜V6 is switched.

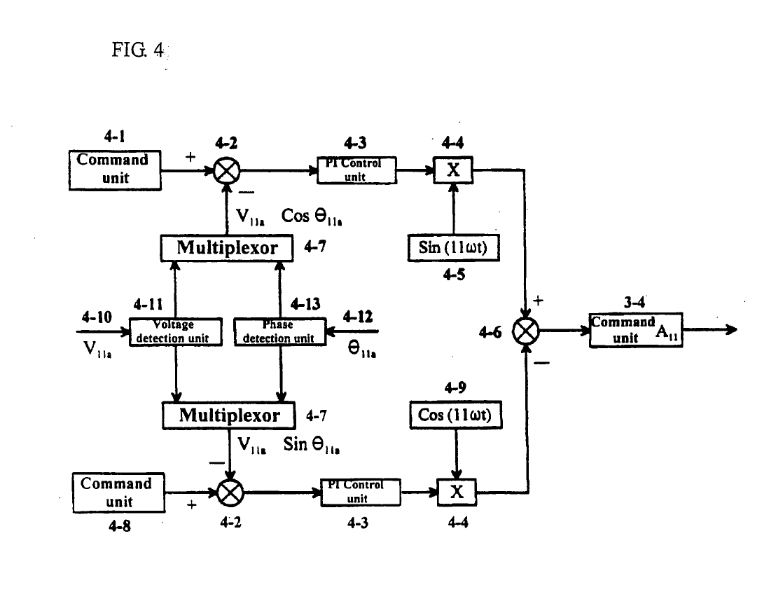

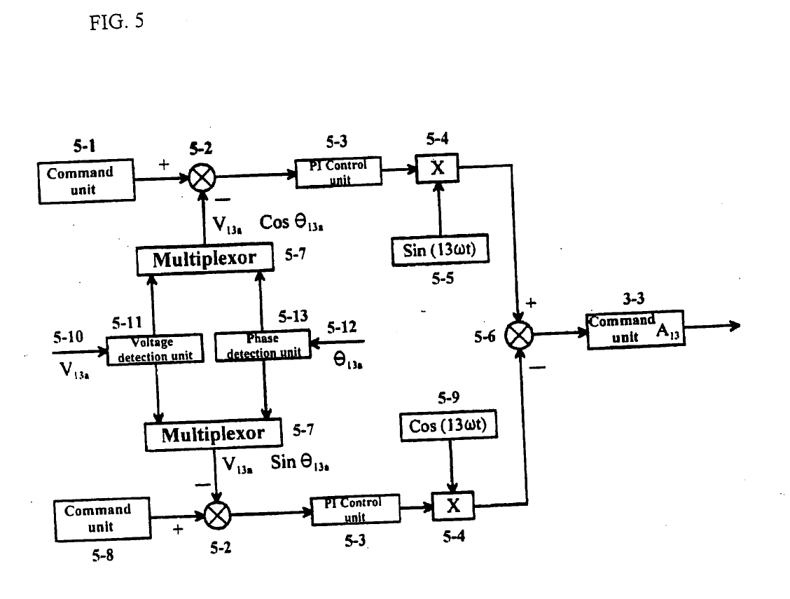

FIG. 3 is a view illustrating the construction that a command value is generated in the command units 3-3 and 3-4. FIG. 4 is a view illustrating the construction that a command signal with respect to a 11^{th} harmonic is generated. FIG. 5 is a view illustrating the construction that a command value with respect to a 13^{th} harmonic is generated.

As shown in FIG. 4, a command value is generated to drive the voltage source converter 7-4 of the active filter of FIG. 7. In a vector control technique, multiplying a direct current signal with an item of cosine forms a real number portion, and multiplying a direct current signal with an item of sine forms an imaginary number portion. A command signal is generated by combining the real and imaginary number portions.

Namely, in the control unit 7-6 of FIG. 7, the signals V₁₁ₐ·cos θ₁₁ₐ obtained by vector-combining the value commanded by the command unit 4-1 of FIG. 4 and the voltage and phase from the signal detection unit 7-5 are scalar-combined by the combining unit 4-2. An error of the same is outputted through the PI control unit 4-3. The signals V₁₁ₐ·sin θ₁₁ₐ obtained by vector-combining a sine(11 ωt) of the frequency conversion unit 4-5 adapted to convert the signal from the PI control unit 4-3 into a 11^{th} frequency, the value multiplied by the multiplier 4-4, the value commanded by the command unit 4-8 and the voltage and phase from the signal detection unit 7-5 are scalar-combined by the other combining unit 4-2. The combined value is outputted through the PI control unit 4-3. Cos(11 ωt) of the frequency conversion unit 4-9 adapted to convert the signal from the PI control unit 4-3 into a 11^{th} frequency, and the value multiplied by the other multiplier 4-4 are combined by the combining unit 4-6 and are outputted to the command unit 3-4 of FIG. 3.

The vector combined signals V₁₁ₐ·cos θ₁₁ₐ are the output of a multiplexor 4-7. The input of the multiplexor 4-7 is connected with the voltage detection unit 4-11 and the phase detection unit 4-13. A 11^{th} harmonic size V₁₁ₐ is supplied to the portion 4-10 in the voltage detection unit 4-11, and the phase θ₁₁ₐ of the 11^{th} harmonic is supplied to the portion 4-12 of the phase detection unit 4-13. The vector combined signals V₁₁ₐ·sin θ₁₁ₐ are the output of the other multiplexor 4-7. The input of the multiplexor 4-7 is connected with the voltage detection unit 4-11 and the phase detection unit 4-13. A 11^{th} harmonic size V₁₁ₐ is supplied to the portion 4-10 in the voltage detection unit 4-11, and the phase θ₁₁ₐ of the 11^{th} harmonic is supplied to the portion 4-12 of the phase detection unit 4-13.

A signal is generated in the command unit 3-3 of FIG. 3 like in FIG. 4. FIG. 4 correspond to the construction that an 11^{th} harmonic command signal is generated, and FIG. 5 corresponds to the construction that a 13^{th} harmonic command value is generated.

Namely, the signals V₁₃ₐ·cos θ₁₃ₐ obtained by vector-combining the value commanded by the command unit 5-1 and the voltage and phase from the signal detection unit 7-5 are scalar-combined by the combining unit 5-2. An error of the same is outputted through the PI control unit 5-3. The signals V₁₃ₐ·sin θ₁₃ₐ obtained by vector-combining a sine(13 ωt) of the frequency conversion unit 5-5 adapted to convert the signal from the PI control unit 5-3 into a 11^{th} frequency, the value multiplied by the multiplier 5-4, the value commanded by the command unit 5-8 and the voltage and phase from the signal detection unit 7-5 are scalar-combined by the other combining unit 5-2. The combined value is outputted through the PI control unit 5-3. Cos(13 ωt) of the frequency conversion unit 5-9 adapted to convert the signal from the PI control unit 5-3 into a 13^{th} frequency, and the value multiplied by the other multiplier 5-4 are combined by the combining unit 5-6 and are outputted to the command unit 3-3 of FIG. 3.

The vector combined signals V₁₃ₐ·cos θ₁₃ₐ are the output of a multiplexor 5-7. The input of the multiplexor 5-7 is connected with the voltage detection unit 5-11 and the phase detection unit 5-13. A 13^{th} harmonic size V₁₃ₐ is supplied to the portion 5-10 in the voltage detection unit 5-11, and the phase θ₁₃ₐ of the 13^{th} harmonic is supplied to the portion 5-12 of the phase detection unit 5-13. The vector combined signals V₁₃ₐ·sin θ₁₃ₐ are the output of the other multiplexor 5-7. The input of the multiplexor 5-7 is connected with the voltage detection unit 5-11 and the phase detection unit 5-13. A 13^{th} harmonic size V₁₃ₐ is supplied to the portion 5-10 in the voltage detection unit 5-11, and the phase θ₁₃ₐ of the 13^{th} harmonic is supplied to the portion 5-12 of the phase detection unit 5-13.

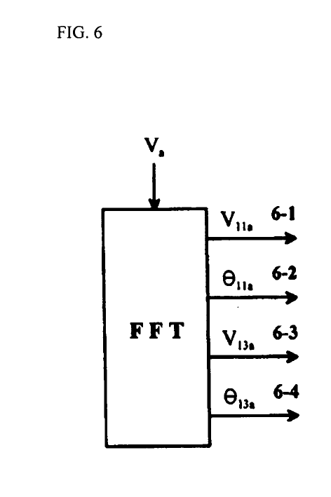

FIG. 7 is a view illustrating the construction of the signal detection unit 7-5 of FIG. 6 in which the size and phase of the 11^{th} harmonic and the size and phase of the 13^{th} harmonic are computed from the phase voltage of the system. The computation of the size and phase of the harmonic from the phase voltage of the system are performed based on the FFT method. Namely, as Va is inputted into the FFT, the size 6-1 of the 11^{th} harmonic which is V₁₁ₐ, the size 6-3 of the 13^{th} harmonic which is V₁₃ₐ, the phase 6-2 of the 11^{th} harmonic which is θ₁₁ₐ, and the phase 6-4 of the 13^{th} harmonic which is θ₁₃ₐ are outputted, respectively.

Therefore, the condenser 7-1-1, the inductance 7-1-2 and the impedance of the resistor 7-1-3 of the passive filter 7-1 of the present invention are adjusted to be minimum in the 12^{th} harmonic. The passive filter is adjusted based on the 12^{th} harmonic. When the voltage source converter 7-4 is controlled in order to remove the 11^{th} and 13^{th} harmonics, the 11^{th} and 13^{th} harmonics of the system are removed.

As described above, in the present invention, the performance of the passive filter is maximized using the converter. Even when the characteristics of the passive filter are changed by a temperature or degradation, the characteristic changes are compensated by the control function of the converter. Therefore, in the present invention, it is possible to provide a 12^{th} active filter capable of obtaining a filer performance for removing 11^{th} and 13^{th} harmonics even when the filter capable of removing 11^{th} and 13^{th} harmonics is constructed using only the 12^{th} filter using the compensation function.

The 12^{th} active filter capable of concurrently removing 11^{th} and 13^{th} harmonics was described in the above. The above description is provided for only an illustrative purpose, not limiting the scope of the present invention.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A 12^{th} active filter capable of concurrently removing 11^{th} and 13^{th} harmonics which is characterized in that a passive filter 7-1 formed of a condenser 7-1-1, an inductance 7-1-2 and a resistor 7-1-3 is formed of the phases A, B and C, and the passive filter 7-1 of each phase is formed in a three-phase structure in which a switch 7-3 and a voltage source converter 7-4 are connected through a transformer 7-2, and in the voltage source converter 7-4, V1˜V6 of a firing unit 7-7 are connected with the bases of the transistors of semiconductor devices V1˜V6, respectively, and a control unit 7-6 connected with a signal detection unit 7-5 is connected with the firing unit 7-7 for thereby removing 11^{th} and 13^{th} harmonics.

2. The filter according to claim 1, wherein in said voltage source converter 7-4, a triangle wave passed through a triangle wave generation unit 3-1 by each phase and a signal from the control unit 7-6, namely, a signal obtained by combining the signals from command units 3-3 and 3-4 by a combining unit, are turned on and off.

3. The filter according to claim 2, wherein in said comparison unit 3-2, a semiconductor device V1 and a semiconductor device V4 passed through an inverter 3-5 are connected with a phase A, and a semiconductor device V3 and a semiconductor device V6 passed through an inverter 3-5 are connected with a phase B, and a semiconductor device V5 and a semiconductor device V2 passed through an inverter 3-5 are connected with a phase C.

4. The filter according to claim 1, wherein in a part of the control unit 7-6, the signals V₁₁ₐ·cos θ₁₁ₐ obtained by vector-combining the value commanded by the command unit 4-1 and the voltage and phase from the signal detection unit 7-5 are combined by the combining unit 4-2 based on the scalar method, and an error of the same is outputted through a PI control unit 4-3, and the signals V₁₁ₐ·sin θ₁₁ₐ obtained by vector-combining a sin (11 ωt) of the frequency conversion unit 4-5 for converting the signal from the PI control unit 4-3 into a 11^{th} frequency, the value multiplied by the multiplier 4-4, the value commanded by the command unit 4-8 and the voltage and phase from the signal detection unit 7-5 are combined by the combining unit 4-2 based on the scalar method, and the combined value is outputted through another PI control unit 4-3, and a cos (11 ωt) of the frequency conversion unit 4-9 adapted to convert the signal from the PI control unit 4-3 into a 11^{th} frequency and a value multiplied by another multiplier 4-4 are combined by the combining unit 4-6 and are outputted to the command unit 3-4.

5. The filter according to claim 1, wherein in a part of said control unit 7-6, the signals V₁₃ₐ·cos θ₁₃ₐ obtained by vector-combining the value commanded by the command unit 5-1 and the voltage and phase from the signal detection unit 7-5 are scalar-combined by the combining unit 5-2, and an error of the same is outputted through the PI control unit 5-3, and the signals V₁₃ₐ·sin θ₁₃ₐ obtained by vector-combining a sin (13 ωt) of the frequency conversion unit 5-5 adapted to convert the signal from the PI control unit 5-3 into a 13^{th} frequency, the value multiplied by the multiplier 5-4, the value commanded by the command unit 5-8 and the voltage and phase from the signal detection unit 7-5 are scalar-combined by another combining unit 5-2, and the combined value is outputted through the PI control unit 5-3, and cos (13 ωt) of the frequency conversion unit 5-9 adapted to convert the signal from the PI control unit 5-3 into a 13^{th} frequency, and the value multiplied by another multiplier 5-4 are combined by the combining unit 5-6 and are outputted to the command unit 3-3.

6. The filter according to claim 1, wherein in a part of the signal detection unit 7-5, Va is inputted into a FFT, and a 11^{th} harmonic size V₁₃ₐ, a 13^{th} harmonic size V₁₃ₐ, a 11^{th} harmonic phase θ₁₁ₐ, and a 13^{th} harmonic phase θ₁₃ₐ are outputted, respectively.
